(19) United States
(12) Patent Application Publication
(10) Pub. No.: US 2008/0219246 A1
(43) Pub. Date: Sep. 11, 2008

(54) System and method for switching using coordinated phase shifters

(75) Inventors: Mansoor K. Siddiqui, Torrance, CA (US); Albert F. Lawrence, Redondo Beach, CA (US); Kai E. Johnson, Redondo Beach, CA (US); Lance B. Sjogren, San Pedro, CA (US)

Correspondence Address: POSZ LAW GROUP, PLC, 12040 SOUTH LAKES DRIVE, SUITE 101, RESTON, VA, 20191, US

(73) Assignee: Northrop Grumman Space and Mission Systems Corp., Los Angeles, CA (US)

(21) Appl. No.: 11/715,432

(22) Filed: Mar. 8, 2007

(51) Int. Cl. H04L 12/50

(52) U.S. Cl. 370/357

(57) ABSTRACT

A switching circuit (100) is provided, comprising: a signal coupler (110) configured to receive first and second input signals and provide first and second coupled signals; a first phase shifter (130) configured to shift a first phase of the first coupled signal by zero degrees or ninety degrees based on a first control signal to generate a first shifted signal; a second phase shifter (135) configured to shift a second phase of the second coupled signal by zero degrees or ninety degrees based on a second control signal to generate a second shifted signal; and a combiner (150) configured to combine the first and second shifted signals. The first coupled signal includes an in-phase copy of the first input signal and a ninety-degree-shifted copy of the second input signal; and the second coupled signal includes an in-phase copy of the second input signal and a ninety-degree-shifted copy of the first input signal.

### FIELD OF THE INVENTION

The present invention relates generally to switches, and more particularly to broadband, high isolation switches with low power loss for use in radiometric applications.

### BACKGROUND

Multiple input-single output switches are used in any situation in which a selection must be made between multiple incoming signals. Traditional switches physically switch between the input nodes and the output node. In this way when a first input signal is chosen instead of a second input signal, the output node is physically connected to the first input node and disconnected from a second input node. Then, when the second input signal is chosen, the output node is physically connected to the second input node and disconnected from the first input node.

However this sort of shifting is often unfeasible at high frequencies, since it becomes increasingly difficult to physically open and close the connections quickly enough. Furthermore, even if it were possible to make the necessary connections at the desired frequency, the switching itself could add an undesirable amount of noise to the signals, could reduce the quality or the bandwidth of the signal being passed by too great an amount, or could impose signal power loss.

An alternative to physical switching is to use circuit elements such as diodes or other semiconductor control elements to effect switching. One path in such a switch would have a low resistance in one state, allowing substantive current to flow, and a high resistance in another state, stopping substantive current from flowing. The other path would have the reverse properties based on the states. This would allow current to flow along one path but not along the other in one state, and the reverse in the other state.

One conventional high-speed, semiconductor switch is the Dicke switch, which is used in radiotelescope receivers to rapidly switch a receiver port between an antenna (i.e., an incoming signal) and a known reference voltage. Another possible switch is a so-called Dicke switch replacement, which is similar to a Dicke switch and also operates to rapidly switch between the incoming signal and the reference voltage. In the Dicke switch replacement, two parallel paths are formed between the input ports (one coupled to the incoming signal, one to the reference voltage) and the output port. In one path, a pair of amplifiers is coupled to a 0-180° phase-shift switch, which, in turn, is connected to an output port. In the alternative path, two amplifiers are connected between the input port and the output port. By amplifying the signal prior to being switched, the Dicke switch replacement can improve the signal-to-noise ratio of the signal passing through the switch.

Regardless, in each of these semiconductor switches, the constant switching on and off elements in either of these switches can add noise and signal loss to any signals passing through them, reducing its available bandwidth and lowering its sensitivity.

It would therefore be desirable to provide a high isolation signal switch that can operate at a high bandwidth with low input loss.

### SUMMARY OF THE INVENTION

Accordingly, the present invention provides a broadband, high isolation switches with low power loss, and/or very little degradation in sensitivity. This allows the isolation of gain prior to the losses of a switch.

A switching circuit is provided, comprising: a signal coupler configured to receive first and second input signals and provide first and second coupled signals; a first phase shifter configured to shift a first phase of the first coupled signal by a first phase amount or a second phase amount based on a first control signal to generate a first shifted signal; a second phase shifter configured to shift a second phase of the second coupled signal by the first phase amount or the second phase amount based on a second control signal to generate a second shifted signal; and a combiner configured to combine the first and second shifted signals. The first coupled signal includes a first phase-shifted copy of the first input signal and a first phase-shifted copy of the second input signal, and the second coupled signal includes a second phase-shifted copy of the second input signal and a second phase-shifted copy of the first input signal. The first phase-shifted copy of the first input signal and the second phase-shifted copy of the first input signal are ninety degrees out of phase, and the first phase-shifted copy of the second input signal and the second phase-shifted copy of the second input signal are ninety degrees out of phase. When the first phase of the first coupled signal is shifted by the first phase amount, the second phase of the second coupled signal is shifted by the second phase amount, and when the first phase of the first coupled signal is shifted by the second phase amount, the second phase of the second coupled signal is shifted by the first phase amount.

The first phase amount may be zero degrees and the second phase amount may be one of ninety degrees and one hundred and eighty degrees.

In one embodiment, the first phase-shifted copy of the first input signal is shifted by zero degrees, the second phase-shifted copy of the first input signal is shifted by ninety degrees, the first phase-shifted copy of the second input signal is shifted by ninety degrees, and the second phase-shifted copy of the second input signal is shifted by zero degrees.

The first signal delay from the first input signal to the first shifted signal may be substantially equivalent to a second signal delay from the second input signal to the second shifted signal.

The switching circuit may further comprise: a first coupled signal amplifier configured to amplify the first coupled signal before the first coupled signal is provided to the first phase shifter; and a second coupled signal amplifier configured to amplify the second coupled signal before the second coupled signal is provided to the second phase shifter.

The switching circuit may further comprise: a first shifted signal amplifier configured to amplify the first shifted signal before the first shifted signal is provided to the combiner; and a second shifted signal amplifier configured to amplify the second shifted signal before the second shifted signal is provided to the combiner.

The combiner may be one of an in-phase combiner or a 180 degree combiner. The signal coupler may be one of a Lange coupler or a branchline coupler. The first and second control signals may be the same signal.

The switching circuit may further comprise: a two-input switch configured to select one of a third and fourth input signal to form the first input signal. The two-input switch may comprise an additional signal coupler and one or more additional phase shifters.

A method of switching signals is also provided, comprising: receiving first and second input signals; generating a first coupled signal that includes a first phase-shifted copy of the first input signal and a second phase-shifted copy of the second input signal; generating a second coupled signal that includes a second phase-shifted copy of the first input signal and a second phase-shifted copy of the second input signal; shifting a first phase of the first coupled signal by a first phase amount or a second phase amount based on a first control signal to generate a first shifted signal; shifting a second phase of the second coupled signal by the first phase amount or the second phase amount based on a second control signal to generate a second shifted signal; and combining the first and second shifted signals to generate an output signal. In this method, when the first phase of the first coupled signal is shifted by the first phase amount, the second phase of the second coupled signal is shifted by the second phase amount, and when the first phase of the first coupled signal is shifted by the second phase amount, the second phase of the second coupled signal is shifted by the first phase amount.

In this method, a first signal delay from the first input signal to the first shifted signal may be substantially equivalent to a second signal delay from the second input signal to the second shifted signal.

The method may further comprise: amplifying the first coupled signal before shifting the first phase of the first coupled signal; and amplifying the second coupled signal before shifting the second phase of the second coupled signal. The method may further comprise: amplifying the first shifted signal before combining the first and second shifted signals; and amplifying the second shifted signal before combining the first and second shifted signals.

The operations of receiving the first and second input signals, generating the first coupled signal, generating the second coupled signal, shifting the first phase of the first coupled signal, shifting the second phase of the second coupled signal, and combining the first and second shifted signals may be repeated multiple times. During each iteration of the shifting of the first phase of the first coupled signal and the shifting of the second phase of the second coupled signal, the first and second control signals may be changed such that in one iteration the first phase of the first coupled signal is shifted by first phase amount and the second phase of the second coupled signal is shifted by second phase amount, and in a next iteration, the first phase of the first coupled signal is shifted by the second phase amount and the second phase of the second coupled signal is shifted by the first phase amount. The iterations may occur with a frequency between 50 microseconds and 1 millisecond.

The method of switching signals may further comprise: receiving third and fourth input signals; generating a third coupled signal that includes a first phase-shifted copy of the third input signal and a second phase-shifted copy of the fourth input signal; generating a fourth coupled signal that includes an second phase-shifted copy of the third input signal and a second phase-shifted copy of the fourth input signal; shifting a third phase of the third coupled signal by the first phase amount or the second phase amount based on a third control signal to generate a third shifted signal; shifting a fourth phase of the fourth coupled signal by the first phase amount or the second phase amount based on a fourth control signal to generate a fourth shifted signal; and combining the third and fourth shifted signals to generate the first input signal.

A switching circuit is also provided, comprising: a signal coupler configured to receive first and second input signals and provide first and second coupled signals; a shift switching element configured to select one of the first and second coupled signals as a shifting signal based on a shifting control signal; a ninety-degree phase shifter configured to shift a shifting phase of the shifting signal by ninety degrees to generate an intermediate shifted signal; a first switching element configured to select one of the first coupled signal and the intermediate shifted signal as a first shifted signal based on a first control signal; a second switching element configured to select one of the second coupled signal and the intermediate shifted signal as a second shifted signal based on a second control signal; and a combiner configured to combine the first and second shifted signals. The first coupled signal may include an in-phase copy of the first input signal and a ninety-degree-shifted copy of the second input signal, while the second coupled signal may include an in-phase copy of the second input signal and a ninety-degree-shifted copy of the first input signal. When the first switching element selects the first coupled signal, the shift switching element may select the second coupled signal and the second switching element may select the intermediate shifted signal, and when the second switching element selects the second coupled signal, the shift switching element may select the first coupled signal and the first switching element may select the intermediate shifted signal.

A first signal delay from the first input signal to the first shifted signal may be substantially equivalent to a second signal delay from the second input signal to the second shifted signal.

A single control signal may be provided as the first, second, and shifting control signals.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 is a block diagram of a two-input switch according to disclosed embodiments;

FIG. 2 is a block diagram of a 0/90° phase shifter of FIG. 1 according to disclosed embodiments;

FIG. 3 is a block diagram of two 0/90° phase shifters sharing a single 90° phase shifter according to disclosed embodiments;

FIG. 4 is a flow chart of a two-input switching operation according to disclosed embodiments;

FIG. 5 is a block diagram of a four-input switch according to disclosed embodiments; and

FIG. 6 is a flow chart of the operation of a four-input switching operation according to disclosed embodiments.

### DETAILED DESCRIPTION OF DISCLOSED EMBODIMENTS

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore or application specific ICs. One particular area of application is with respect to microwave monolithic integrated circuits (MMICs). It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

Applicants referring below to the drawings in which like numbers reference like components, and in which a single reference number may be used to identify an exemplary one of multiple like components

Two-Input Switch

FIG. 1 is a block diagram of a two-input switch according to disclosed embodiments. This could also be referred to as a three-port switch. As shown in FIG. 1, the two-input switch 100 includes a 4-port coupler 110, amplifiers 120, 125, 140, and 145, 0/90° phase shifters 130 and 135, and a combiner 150.

The 4-port coupler 110 receives a first input signal at a first port and a second input signal at a second port, and produces a first coupled signal at a third port and a second coupled signal at a fourth port. The first coupled signal includes a portion of the first input signal with a 0° phase shift (i.e., unshifted in phase), and a portion of the second input signal with a 90° phase shift. The second coupled signal includes a portion of the first input signal with a 90° phase shift, and a portion of the second input signal with a 0° phase shift (i.e., unshifted in phase). The 4-port coupler 110 in this embodiment can be any suitable 90° coupler, e.g., a Lange coupler, a branchline coupler, or the like. Alternate embodiments could also employ a 3-port coupler.

Although this embodiment describes 0° phase shifts and 90° phase shifts, other phase shift values are possible. However, the relative phase shift between the portion of the first input signal in the first coupled signal and the portion of the first input signal in the second coupled signal should be essentially 90°. Likewise, the relative phase shift between the portion of the second input signal in the first coupled signal and the portion of the second input signal in the second coupled signal should be essentially 90°. In other words, the coherency of the signals should be maintained. Also, when the specification describes specific phase shifts (e.g., 0° and 90° phase shifts), it should be understood that small variations in these phase shifts can be tolerated.

The amplifier 120 serves to amplify the first coupled signal prior to it being provided to the 0/90° phase shifter 130. Likewise, the amplifier 125 serves to amplify the second coupled signal prior to it being provided to the 0/90° phase shifter 135. These amplifiers may be low noise amplifiers (LNAs). In alternate embodiments either or both of the amplifiers 120 or 125 can be eliminated.

The 0/90° phase shifter 130 shifts the phase of the first coupled signal by 0° or 90° based on the value of a first control signal. Likewise, the 0/90° phase shifter 135 shifts the phase of the second coupled signal by 0° or 90° based on the value of a second control signal.

The 0/90° phase shifters 130, 135 can be any suitable phase shifters, including lumped element low pass/high pass switching phase shifters, Schifman phase shifters, or the like.

In operation, the first and second control signals are generated such that when the 0/90° phase shifter 130 shifts the phase of the first coupled signal by 0°, the 0/90° phase shifter 135 shifts the phase of the second coupled signal by 90°, and when the 0/90° phase shifter 130 shifts the phase of the first coupled signal by 90°, the 0/90° phase shifter 135 shifts the phase of the second coupled signal by 0°. Thus, at any given time, one coupled signal will be shifted by 0° and the other will shifted by 90°.

In some alternate embodiments a single control signal can be provided as both the first control signal and the second control signal. In such embodiments the 0/90° phase shifter 130 and the 0/90° phase shifter 135 should be designed to respond in opposite ways to the single control signal.

The amplifier 140 serves to amplify a first shifted signal after it is output from the 0/90° phase shifter 130, and prior to it being provided to the combiner 150. Likewise, the amplifier 145 serves to amplify a second shifted signal after it is output from the 0/90° phase shifter 135, and prior to it being provided to the combiner 150. These amplifiers may be low noise amplifiers (LNAs). In alternate embodiments the either or both of the amplifiers 140 or 145 can be eliminated.

The combiner 150 takes the first shifted signal and the second shifted signal and combines them together into a final output signal for the two-input switch 100. This can be implemented as an in-phase combiner or a 180° combiner in various embodiments. In an alternate embodiment the combiner can be implemented as a four-port combiner, with two output lines that each toggle between outputting one of the two input signals, generally in opposite orientations with respect to each other.

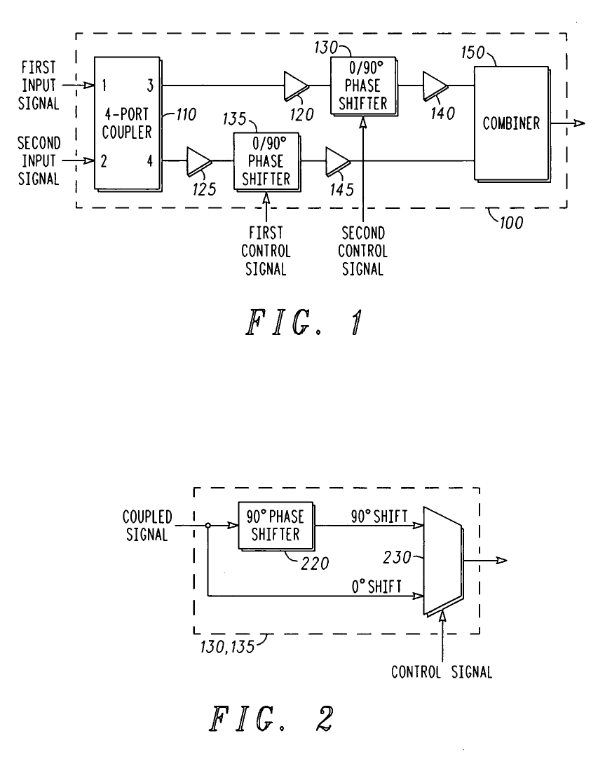

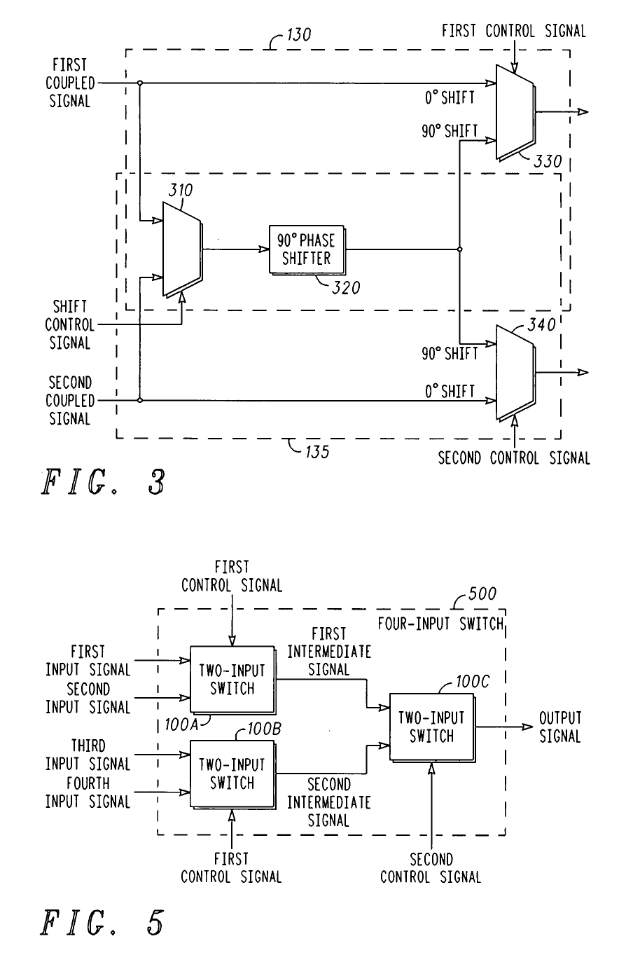

FIG. 2 is a block diagram of a 0/90° phase shifter of FIG. 1 according to disclosed embodiments. As shown in FIG. 2, the exemplary 0/90° phase shifter 130, 135 includes a 90° phase shifter 220, and a multiplexer 230.

The 90° phase shifter 220 receives an incoming signal and shifts it by 90° to generate a 90° shifted signal. The 90° phase shifter 220 can be a Schiffman phase shifter, a high-pass/low-pass response circuit, or any suitable 90° phase shifting circuit. A broadband 90° phase shifter 220 may be selected for certain embodiments that must operate over a wide frequency band.

The multiplexer 230 receives the unshifted incoming signal (i.e., the 0° shifted signal) and the 90° shifted signal, and outputs one of these signals based on the value of a received control signal. In this way the 0/90° phase shifter 130 generates either a 0° shifted signal (i.e., an unshifted signal) or a 90° shifted signal based on the value of the control signal. Although the disclosed embodiments show the use of multiplexers here and other places for selecting between signals, other selection circuits or switches can be used in alternate embodiments.

It should be noted that the 0/90° phase shifter 130, 135 of FIG. 2 is shown simply by way of example. Other types of 0/90° phase shifter 130, 135 could be used in alternate embodiments.

FIG. 3 is a block diagram of two 0/90° phase shifters sharing a single 90° phase shifter according to disclosed embodiments. As shown in FIG. 3, two 0/90° phase shifters 130 and 135 are provided. The first 0/90° phase shifter 130 includes a wave delay multiplexer 310, a 90° phase shifter 320, a first phase shifter multiplexer 330. The second 0/90° phase shifter 130 includes the wave delay multiplexer 310, the 90° phase shifter 320, and a second phase shifter multiplexer 340.

The wave delay multiplexer 310 receives the first coupled signal and the second coupled signal as input signals. It provides one of the first and second coupled signals as an output signal based on the value of a wave delay control signal. Although the disclosed embodiment show the use of a multiplexer here, other selection circuits or switches can be used in alternate embodiments.

The 90° phase shifter 320 operates just as 90° phase shifter 220 of FIG. 2, receiving a coupled signal (either the first or the second coupled signal) as an input signal, and shifting its phase by 90°.

The first and second phase shifter multiplexers 330 and 340 operate just as the multiplexer 230 of FIG. 2. Each receives its respective unshifted coupled signal as well as the output of the 90° phase shifter 320, and outputs either the unshifted coupled signal or a 90°-shifted signal as an output based on the first and second control signals, respectively

The two 0/90° phase shifters 330 and 340 can share the same 90° phase shifter 320 because one will always be shifting its coupled signal by 0° when the other is shifting its coupled signal 90°. As a result, they will never both need to shift their respective coupled signal by 90° at the same time. The resulting device can eliminate the need to provide two 90° phase shifters at the price of adding the wave delay multiplexer 310 and providing for the wave delay control signal. This can save valuable chip space, lowering the cost of the final design.

In addition, although the embodiment of FIG. 3 is shown as having separate first, second, and shift control signals, in some embodiments the multiplexers 310, 330, and 340 can be designed to be controlled by the a single control signal. This can serve to reduce the complexity of this design as compared to one employing two separate 90° phase shifters, by eliminating one control line in each switch.

Although the circuit of FIG. 3 is described as two separate 0/90° phase shifters 130 and 135, which share a 90° phase shifter 320, this circuit could also be considered to functionally be a four-port 0/90° phase shifter that accepts two input signals and outputs one of the signals with a 0° phase shift, and outputs the other signal with a 90° phase shift.

The switch described above with respect to FIGS. 1-3 can be implemented in a monolithic integrated circuit design, such as a microwave monolithic integrated circuit (MMIC). In particular, it could be used for a switch in a radiometer low noise amplifier (LNA) on a single MMIC, with a first input port of the switch being connected to a reference element and a second input port of the switch being connected to an antenna. Such an MMIC device could contain one or more stages of gain, thereby forming a complete monolithic radiometer LNA.

Two-Input Switching Method

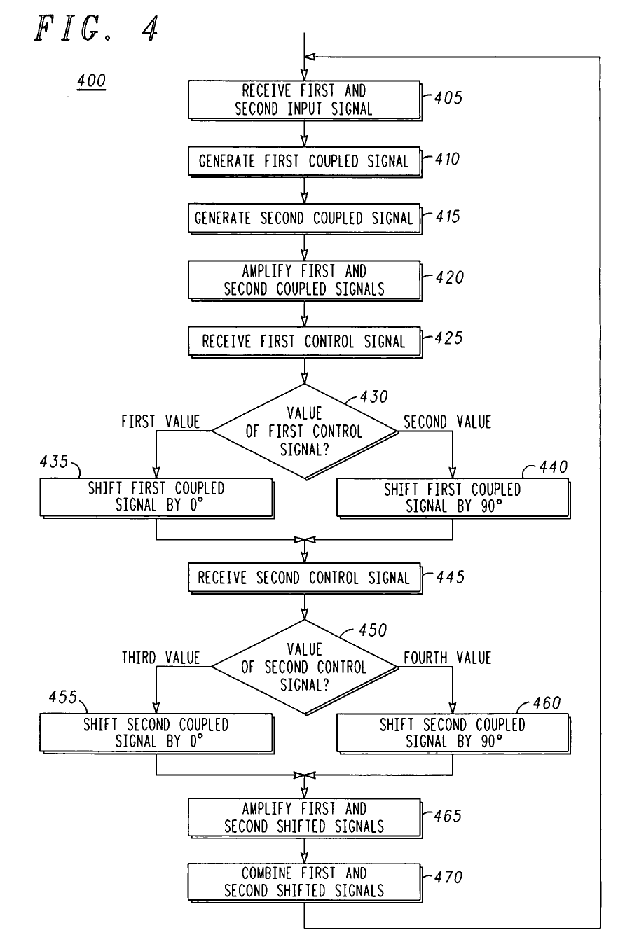

FIG. 4 is a flow chart of a two-input switching operation according to disclosed embodiments. As shown in FIG. 4, the operation 400 begins when a switch receives the first and second input signals. (405)

The switch then generates a first coupled signal that includes a portion of the first input signal with a 0° phase shift (i.e., unshifted in phase), and a portion of the second input signal with a 90° phase shift (410); and generates a second coupled signal that includes a portion of the first input signal with a 90° phase shift, and a portion of the second input signal with a 0° phase shift (i.e., unshifted in phase). (415)

In other words, if the phase of the first input signal is Φ₁ and the phase of the second input signal is Φ₂, the two portions of the first coupled signal can be written as S_{I1}(Φ₁)+S_{I2}(Φ₂+90°), and the two portions of the second coupled signal can be written as S_{I1}(Φ₁+90°)+S_{I2}(Φ₂). The amplitude of the portions of the input signals in each coupled signal may not be the same as the amplitude of the corresponding input signal, but corresponding signal portions in each of the coupled signals should be approximately equal.

The switch then amplifies the first and second coupled signals (420), though in some embodiments this operation can be eliminated.

The switch receives a first control signal (425) and determines whether it has a first or second value. (430) In a disclosed embodiment this can be a logical “1” or “0” value, though other values can be used in alternate embodiments.

Based on the value of the first control signal, the switch either shifts the phase of the first coupled signal by 0° or 90°. In particular, if the first control signal has a first value, the switch shifts the phase of the first coupled signal by 0° (435), and if the first control signal has a second value, the switch shifts the phase of the first coupled signal by 90°. (440)

The switch also receives a second control signal (445) and determines whether it has a third or fourth value. (450) In a disclosed embodiment this can be a logical “1” or “0” value, though other values can be used in alternate embodiments.

Based on the value of the second control signal, the switch either shifts the phase of the second coupled signal by 0° or 90°. In particular, if the second control signal has a third value, the switch shifts the phase of the second coupled signal by 0° (455), and if the second control signal has a fourth value, the switch shifts the phase of the second coupled signal by 90°. (460)

The values of the first and second control signals are chosen such that at any given time one of the first and second coupled signals will be shifted by 0° (i.e., will remain unshifted), and the other of the first and second coupled signals will be shifted by 90°.

In some embodiments the first and second control signals can both be the same signal. If this is so, the operation of receiving a second control signal (445) can be eliminated, and the operation of determining the value of the second control signal (450) involves determining the value of the first control signal with slightly different criteria than the first determination (430).

If the first and second control signals are the same, the first and fourth values will be the same, and the second and third values will be the same. As a result, a given value of the first control signal will provoke a different value for the second phase shift, as compared to the first phase shift. In particular, when the control signal has the first/fourth value the switch shifts the phase of the first coupled signal by 0°and shifts the phase of the second coupled signal by 90°; and when the control signal has the second/third value the switch shifts the phase of the first coupled signal by 90° and shifts the phase of the second coupled signal by 0°.

Once the first and second coupled signals are shifted in phase (by 0° or 90°), the switch can them amplify the resulting first and second shifted signals (465), though in some embodiments this operation can be eliminated.

Finally, the switch will combine the first and second shifted signals (whether amplified or not) to form an output signal. (470)

It should be noted that throughout this description, the term “shifted signal” is used for clarity of description when the describing both signals having a 0° phase shift and signals having a 90° phase shift. It is understood that a signal with a 0° phase shift is technically not shifted at all, but passed without any change in phase. The term “shifted angle” is used to describe a signal after the performance of whatever phase shifting it is going to experience.

The combination of the coupling, shifting, and combining described above allows the switch to select one of the first and second input signals by manipulating the phases of the first and second shifted signals that are combined to form the output signal.

TABLE ONE shows how the phases of the first and second shifted signals are changed depending upon which input signal the switch is to pass. This table will neglect the signal delay in each signal path, since the switch should keep these signal delays approximately equal in each of the signal paths.

TABLE ONE

| | First | Second | | |
|---|---|---|---|---|
| Output | Phase | Phase | | |
| Signal | Shift | Shift | First Shifted Signal | Second Shifted Signal |
| First | 90° | 0° | S_{I1} (Φ₁ + 90°) + | S_{I1} (Φ₁ + 90°) + |
| Input | | | S_{I2} (Φ₂ + 180°) | S_{I2} (Φ₂ + 0°) |
| Signal | | | | |
| Second | 0° | 90° | S_{I1} (Φ₁ + 0°) + | S_{I1} (Φ₁ + 180°) + |
| Input | | | S_{I2} (Φ₂ + 90°) | S_{I2} (Φ₂ + 90°) |
| Signal | | | | |

As shown in TABLE ONE, if the switch is to select the first input signal, it will employ a first phase shift for the first coupled signal of 90° and a second phase shift for the second coupled signal of 0°. Since the first coupled signal contains a portion of the first input signal shifted by 0° and a portion of the second input signal shifted by 90° (i.e., S_{I1}(Φ₁+0°)+S_{I2}(Φ₂+90°)), the resulting first shifted signal will include a portion of the first input signal shifted by 90° and a portion of the second input signal shifted by 180° (i.e., S_{I1}(Φ₁+90°)+S_{I2}(Φ₂+180°)).

Similarly, since the second coupled signal is passed with no phase shift in this instance, the resulting second shifted signal will include a portion of the first input signal shifted by 90°, and a portion of the second input signal shifted by 0° (i.e., S_{I1}(Φ₁+90°)+S_{I2}(Φ₂+0°)), just as with the second coupled signal.

When the first and second shifted signals are combined to form the output signal, the portions of the second input signal contained in these shifted signals will cancel each other out, since they are out of phase by 180° from each other (i.e., the first shifted signal contains a portion of the second signal that is shifted by 180° and the second shifted signal contains a portion of the second signal that is shifted by 0°). Likewise, the portions of the first input signal contained in these shifted signals will add together, since they are in phase with each other (i.e., the first shifted signal and the second shifted signal each contain a portion of the first signal that is shifted by 90°). Thus, the resulting output signal will contain a portion of the first signal and no part of the second signal, i.e., it will have passed only the first signal and not the second signal.

As shown in TABLE ONE, if the switch is to select the second input signal, it will shift the first coupled signal by 0° and the second coupled signal by 90°. Since the first coupled signal is passed with no phase shift in this instance, the resulting first shifted signal will include a portion of the first input signal shifted by 0°, and a portion of the second input signal shifted by 90° (i.e., S_{I1}(Φ₁+0°)+S_{I2}(Φ₂+90°)), just as with the first coupled signal.

Similarly, since the second coupled signal contains a portion of the first input signal shifted by 90° and a portion of the second input signal shifted by 0° (i.e., S_{I1}(Φ₁+90°)+S_{I2}(Φ₂+0°)), the resulting second shifted signal will include a portion of the first input signal shifted by 180°, and a portion of the second input signal shifted by 90° (i.e., S_{I1}(Φ₁+180°)+S_{I2}(Φ₂+90°)).

When the first and second shifted signals are combined to form the output signal, the portions of the first input signal contained in these shifted signals will cancel each other out, since they are out of phase by 180° from each other (i.e., the first shifted signal contains a portion of the first signal that is shifted by 0° and the second shifted signal contains a portion of the first signal that is shifted by 180°). Likewise, the portions of the second input signal contained in these shifted signals will add together, since they are in phase with each other (i.e., the first shifted signal and the second shifted signal each contain a portion of the second signal that is shifted by 90°). Thus, the resulting output signal will contain a portion of the second signal and no part of the first signal, i.e., it will have passed only the second signal and not the first signal.

This cancellation process is possible because the signal path from the first input node to the output node has approximately the same phase delay as the signal path from the second input node to the output node. This means that when the 0/90° phase shifters 130 and 135 shift the phases of the two signal paths, their relative phase with respect to each other will remain constant. Thus, it's possible to predict when portions will be in-phase with each other and when they will be 180° out of phase with each other.

In some embodiments, e.g., radiometer receivers, the switch may rapidly alternate between selecting one input and another, repeatedly performing this operation in rapid succession. In one particular embodiment, the inputs could be alternated at a frequency of about 50 microseconds to 1 millisecond.

Although the above examples all use 0/90° phase shifters, this is simply by way of example. Those skilled in the art would understand that other embodiments could use different phase shifters. For example, a 0/180° phase shifter could be used. In this case, the relative phase differences between signal portions in the coupled signals should be essentially 180°. Other phase shift values are also possible. In each different embodiment, however, the relative phases of the signal portions along each signal path should be maintained such that portions from one input signal will add together, enhancing the effects of the one input signal, and portions from the other input signal will subtract, canceling the effects of the other input signal

Multiple-Input Switch

Although the above examples describe a two-input switch 100, the general switching design can be extended into switches having more than two input signals in alternate embodiments. Typically this is done by cascading two-input switches together. A four-input switch will be described below as an example of how the concept can be extended to a larger number of input signals. One skilled in the art would understand, based on this example, how other numbers of input signals could also be accommodated.

FIG. 5 is a block diagram of four-input switch according to disclosed embodiments. This could also be referred to as a five-port switch. As shown in FIG. 5, the four-input switch 500 includes three two-input switches 100A, 100B, and 100C connected together in a cascade circuit.

The two-input switch 100A receives first and second input signals and selects one as a first intermediate signal based on a first control signal. The two-input switch 100B receives third and fourth input signals and selects one as a second intermediate signal based on the first control signal. The two-input switch 100C receives a first and second intermediate signals and selects one as an output signal based on a second control signal. In this way the four input switch receives the first, second, third, and fourth input signals could be used for each two-input switch.

In the embodiment disclosed in FIG. 5, each two-input switch 100A, 100B, and 100C is controlled by a single control signal, as described above. In alternate embodiments multiple control signals could be used for each two-input switch.

The two-input switch 100A and the two-input switch 100B are controlled by the control signal in this embodiment (i.e., the first control signal). This is possible since the signal selection process is only relevant in one of the two-input switches 100A and 100B at any given time. For example, if the four-input switch 500 needs to select the third input signal, then the two-input switch 100B must pass the third input signal as the as the second intermediate signal, and the two-input switch 100C must pass the second intermediate signal as the output signal. But the output of the two-input switch 100A (i.e., the first intermediate signal) is not relevant in this case since the two-input switch 100C will not select the first intermediate signal. And so it does not matter which of the first and second signals are chosen to be passed as the first intermediate signal.

As a result of this, the four-input switch 500 can select one of the four input signals as the output signal using only two control signals, which can correspond to two control bits. For example, if the control signals have values of “0” and “1,” then the four-input switch 500 could select the first input signal when the two control bits had a value of 00, could select the second input signal when the two control bits had a value of 01, could select the third input signal when the two control bits had a value of 10, and could select the fourth input signal when the two control bits had a value of 11. Other configurations are, of course, possible.

One skilled in the art would understand how this design could be extended into larger or smaller numbers of input signals by cascading an appropriate number of two-input switches together. In particular, a cascade of depth N (i.e., including N stages of two-input switches, each additional stage having up to twice as many switches as the previous stage) will be able to accommodate up to 2^{N} input signals. Where a number of input signals is less than 2^{N} but larger than 2^{N-1}, some signals may pass through one or more stages without the need for switching. For example, one embodiment of a three-input switch would be similar to the four-input switch 500 of FIG. 5, except the two-input switch 100B could be eliminated and the third input signal provided directly to the two-input switch 100C as the second intermediate signal.

Multiple-Input Switching Method

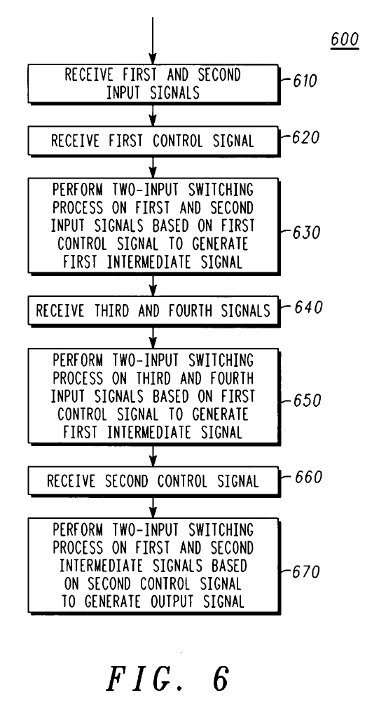

FIG. 6 is a flow chart of the operation of a four-input switching operation according to disclosed embodiments.

As shown in FIG. 6, the four-input switching operation 600 begins by having a switch receive first and second input signals (610) and receive a first control signal. (620) The switch then performs a two-input switching process on the first and second input signals, based on the value of the first control signal, to generate a first intermediate signal. (630)

The switch also receives third and fourth input signals. (640) The switch then performs a two-input switching process on the third and fourth input signals, based on the value of the first control signal, to generate a second intermediate signal. (650)

Although FIG. 6 shows the generation of the first intermediate signal as being before the generation of the second intermediate signal, this is simply for ease of disclosure. The first, second, third, and fourth signals can be received in any order, or at the same time. And the generation of the first and second intermediate signals can likewise be performed in any order or at the same time.

After the first and second intermediate signals are both generated, the switch receives a second control signal (660) and performs a two-input switching process on the first and second intermediate signals, based on the value of the second control signal, to generate an output signal. (670)

Larger or smaller numbers of input signals would simply require more or fewer two-input switching operations to winnow down the available signal choices.

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as described by implementation.

What is claimed is:

1. A switching circuit, comprising:
a signal coupler configured to receive first and second input signals and provide first and second coupled signals;
a first phase shifter configured to shift a first phase of the first coupled signal by a first phase amount or a second phase amount based on a first control signal to generate a first shifted signal;
a second phase shifter configured to shift a second phase of the second coupled signal by the first phase amount or the second phase amount based on a second control signal to generate a second shifted signal; and
a combiner configured to combine the first and second shifted signals,
wherein the first coupled signal includes a first phase-shifted copy of the first input signal and a first phase-shifted copy of the second input signal,
wherein the second coupled signal includes a second phase-shifted copy of the second input signal and a second phase-shifted copy of the first input signal,
wherein the first phase-shifted copy of the first input signal and the second phase-shifted copy of the first input signal are ninety degrees out of phase,
wherein the first phase-shifted copy of the second input signal and the second phase-shifted copy of the second input signal are ninety degrees out of phase,
wherein when the first phase of the first coupled signal is shifted by the first phase amount, the second phase of the second coupled signal is shifted by the second phase amount, and
wherein when the first phase of the first coupled signal is shifted by the second phase amount, the second phase of the second coupled signal is shifted by the first phase amount.

2. The switching circuit, as recited in claim 1, wherein the first phase amount is zero degrees and the second phase amount is one of ninety degrees and one hundred and eighty degrees.

3. The switching circuit, as recited in claim 1, wherein the first phase-shifted copy of the first input signal is shifted by zero degrees, the second phase-shifted copy of the first input signal is shifted by ninety degrees, the first phase-shifted copy of the second input signal is shifted by ninety degrees, and the second phase-shifted copy of the second input signal is shifted by zero degrees.

4. The switching circuit, as recited in claim 1, wherein a first signal delay from the first input signal to the first shifted signal is substantially equivalent to a second signal delay from the second input signal to the second shifted signal.

5. The switching circuit, as recited in claim 1, further comprising:
a first coupled signal amplifier configured to amplify the first coupled signal before the first coupled signal is provided to the first phase shifter; and
a second coupled signal amplifier configured to amplify the second coupled signal before the second coupled signal is provided to the second phase shifter.

6. The switching circuit, as recited in claim 1, further comprising:
a first shifted signal amplifier configured to amplify the first shifted signal before the first shifted signal is provided to the combiner; and
a second shifted signal amplifier configured to amplify the second shifted signal before the second shifted signal is provided to the combiner.

7. The switching circuit, as recited in claim 1, wherein the combiner is one of an in-phase combiner or a 180 degree combiner.

8. The switching circuit, as recited in claim 1, wherein the first and second control signals are the same signal.

9. The switching circuit, as recited in claim 1, wherein the signal coupler is one of a Lange coupler or a branchline coupler.

10. The switching circuit, as recited in claim 1, further comprising:
a two-input switch configured to select one of a third and fourth input signal to form the first input signal,
wherein the two-input switch comprises an additional signal coupler and one or more additional phase shifters.

11. A method of switching signals, comprising:
receiving first and second input signals;
generating a first coupled signal that includes a first phase-shifted copy of the first input signal and a second phase-shifted copy of the second input signal;
generating a second coupled signal that includes a second phase-shifted copy of the first input signal and a second phase-shifted copy of the second input signal;
shifting a first phase of the first coupled signal by a first phase amount or a second phase amount based on a first control signal to generate a first shifted signal;
shifting a second phase of the second coupled signal by the first phase amount or the second phase amount based on a second control signal to generate a second shifted signal; and
combining the first and second shifted signals to generate an output signal,
wherein when the first phase of the first coupled signal is shifted by the first phase amount, the second phase of the second coupled signal is shifted by the second phase amount, and
wherein when the first phase of the first coupled signal is shifted by the second phase amount, the second phase of the second coupled signal is shifted by the first phase amount.

12. The method of switching signals recited in claim 11, wherein a first signal delay from the first input signal to the first shifted signal is substantially equivalent to a second signal delay from the second input signal to the second shifted signal.

13. The method of switching signals recited in claim 11, further comprising:
amplifying the first coupled signal before shifting the first phase of the first coupled signal; and
amplifying the second coupled signal before shifting the second phase of the second coupled signal.

14. The method of switching signals recited in claim 13, further comprising:
amplifying the first shifted signal before combining the first and second shifted signals; and
amplifying the second shifted signal before combining the first and second shifted signals.

15. The method of switching signals recited in claim 11, wherein the operations of receiving the first and second input signals, generating the first coupled signal, generating the second coupled signal, shifting the first phase of the first coupled signal, shifting the second phase of the second coupled signal, and combining the first and second shifted signals are repeated multiple times.

16. The method of switching signals recited in claim 15, wherein during each iteration of the shifting of the first phase of the first coupled signal and the shifting of the second phase of the second coupled signal, the first and second control signals are changed such that in one iteration the first phase of the first coupled signal is shifted by first phase amount and the second phase of the second coupled signal is shifted by second phase amount, and in a next iteration, the first phase of the first coupled signal is shifted by the second phase amount and the second phase of the second coupled signal is shifted by the first phase amount.

17. The method of switching signals recited in claim 16, wherein the iterations occur with a frequency between 50 microseconds and 1 millisecond.

18. The method of switching signals recited in claim 11, further comprising:
receiving third and fourth input signals;
generating a third coupled signal that includes a first phase-shifted copy of the third input signal and a second phase-shifted copy of the fourth input signal;
generating a fourth coupled signal that includes an second phase-shifted copy of the third input signal and a second phase-shifted copy of the fourth input signal;
shifting a third phase of the third coupled signal by a first phase amount or a second phase amount based on a third control signal to generate a third shifted signal;
shifting a fourth phase of the fourth coupled signal by the first phase amount or the second phase amount based on a fourth control signal to generate a fourth shifted signal; and
combining the third and fourth shifted signals to generate the first input signal.

19. A switching circuit, comprising:
a signal coupler configured to receive first and second input signals and provide first and second coupled signals;
a shift switching element configured to select one of the first and second coupled signals as a shifting signal based on a shifting control signal;
a phase shifter configured to shift a shifting phase of the shifting signal by a known amount to generate an intermediate shifted signal;
a first switching element configured to select one of the first coupled signal and the intermediate shifted signal as a first shifted signal based on a first control signal;
a second switching element configured to select one of the second coupled signal and the intermediate shifted signal as a second shifted signal based on a second control signal; and
a combiner configured to combine the first and second shifted signals,
wherein the first coupled signal includes an in-phase copy of the first input signal and a phase-shifted copy of the second input signal,
wherein the second coupled signal includes an in-phase copy of the second input signal and a phase-shifted copy of the first input signal,
wherein when the first switching element selects the first coupled signal, the shift switching element selects the second coupled signal and the second switching element selects the intermediate shifted signal, and
wherein when the second switching element selects the second coupled signal, the shift switching element selects the first coupled signal and the first switching element selects the intermediate shifted signal.

20. The switching circuit, as recited in claim 19, wherein a first signal delay from the first input signal to the first shifted signal is substantially equivalent to a second signal delay from the second input signal to the second shifted signal.

21. The switching circuit, as recited in claim 19, wherein a single control signal is provided as the first, second, and shifting control signals.
